(19) United States
(12) Patent Application Publication
(10) Pub. No.: US 2004/0253351 A1
(43) Pub. Date: Dec. 16, 2004

(54) Apparatus and method for mixing confectionary with fluids

(76) Inventor: Lynn Ramblas Killips, Mill Valley, CA (US)

Correspondence Address: John W. Carpenter, Carpenter & Kulas, LLP, Suite 109, 1900 Embarcadero Road, Palo Alto, CA, 94303, US

(21) Appl. No.: 10/459,995

(22) Filed: Jun. 11, 2003

(51) Int. Cl. A23B 4/00

(52) U.S. Cl. 426/115

(57) ABSTRACT

A method for preparing a soda/confectionary mixture comprising coupling a container base to a bottle containing soda, disposing a frozen confectionary in the base, and coupling a container top to the container base to produce a container having the frozen confectionary. The method additionally includes contacting the frozen confectionary with the soda for producing a soda/confectionary mixture within the container, and removing the soda/confectionary mixture from the container. An assembly for mixing soda with a ice cream comprising soda, a ice cream, or the like, disposed in a container communicating with the soda, and at least one straw secured to the container.

### BACKGROUND OF THE INVENTION

1. Field of Invention

Embodiments of the present invention broadly relate to an apparatus and method for mixing confectionary with fluids. More specifically, embodiments of the present invention provide for an apparatus and method for mixing frozen confectionary, such as ice cream or yogurt, with such fluids as soda pope (e.g., root beer, coca cola, etc.)

2. Description of the Background Art

Soda floats, such as root beer floats, have long been favorites as a desert. Soda floats are prepared by mixing soda floats and ice cream, or yogurt, or the like, in a suitable container. Such preparation, however, requires that the ice cream or yogurt be removed from its associated carton and disposed in a suitable separate container, along with pouring the soda from a soda bottle or soda can into the separate container. Thus, a container separate from the soda bottle or soda, and separate from the ice cream/yogurt carton, is required for preparing conventional soda floats.

What is needed and what has been invented is an assembly and method for facilitating the mixing of confectionary with fluids. What is more particularly needed and what has been invented is an assembly and method for mixing and/or contacting ice cream or yogurt with soda pop (e.g., root beer, coca cola, etc.) to produce a confectionary/soda mixture.

### SUMMARY OF EMBODIMENTS OF THE INVENTION

Embodiments of the present invention provide a method for preparing a soda/confectionary mixture comprising coupling a container base to a bottle containing soda, disposing a frozen confectionary in the container base, and coupling (e.g., by screwing or snapping to produce a water tight fit) a container top to a container base to produce a container having the frozen confectionary. The method additionally includes contacting the frozen confectionary with the soda for producing a soda/confectionary mixture within the container, and removing (e.g., by flowing through and/or sucking on a straw) the soda/confectionary mixture from the container. The soda is removed from the bottle (e.g., such as by tilting the bottle for gravity flowing the soda) prior to contacting the frozen confectionary with the soda. The method may additionally include positioning a platform (e.g., a grid) in the base prior to the disposing the frozen confectionary in the base. The platform supports the frozen confectionary. The frozen confectionary is preferably disposed from an inside surface of the base container so as to leave an air space for the soda to pass through after the soda leaves the bottle.

Embodiments of the present invention also provide a method for preparing a soda/confectionary mixture comprising inserting into soda a base straw depending from a container base, disposing a frozen confectionary in the container base, coupling a container top to the container base to produce a container having the frozen confectionary. The method also includes creating a vacuum in a top straw extending from the container top to cause soda to flow through the base straw and contact the frozen confectionary to produce a soda/confectionary mixture within the container, and continuing the creating of the vacuum in the top straw for removing the soda/confectionary mixture from the container. The top straw and/or the base straw may include a cross-brace secured to an inside surface thereof. In an embodiment of the invention the soda is disposed in a can, and the method may additionally comprise producing an aperture in the can, passing the base straw through the aperture and into the soda, passing the base straw through a cap, and coupling the cap over the top of the can. In another embodiment of the invention the soda is disposed in a cup, and the method additionally comprises passing the base straw through a collar of an adapter assembly, and inserting a rim of the cup into space between bifurcated coupling members of the adapter assembly.

Embodiments of the present invention further provide various assemblies for mixing soda, or the like, with a frozen confectionary, such as ice cream. The assemblies include a frozen confectionary disposed in a container which communicates with soda. At least one straw is secured to the container. A platform may be positioned in the container for supporting the frozen confectionary. The container holding the frozen confectionary comprises a container base and a container top secured (e.g., threadably engaged, snapped together, etc.) to the container base in a water tight manner, such that when soda and frozen confectionary contacts and mixes together to form a soda/confectionary mixture within the container, the formed mixture will not leak out of the container. The assemblies (e.g. the container base) are coupled to and are supported by a soda container, such as soda pop bottle, soda pop can, or a cup containing soda.

These provisions together with the various ancillary provisions and features which will become apparent to those artisans possessing skill in the art as the following description proceeds are attained by devices, assemblies, systems and methods of embodiments of the present invention, various embodiments thereof being shown with reference to the accompanying drawings, by way of example only, wherein:

### BRIEF DESCRIPTION OF THE DRAWINGS

FIG. 1A is a front elevational view of an assembly coupled to a neck of a soda pop bottle for receiving soda from the bottle to mix with a frozen confectionary to produce a soda/confectionary mixture within a container of the assembly.

FIG. 1B is a top plan view of a grid which is disposed in the container base for supporting frozen confectionary.

FIG. 1C is a horizontal sectional view taken in direction of the arrows and along the plane of line 1C-1C in FIG. 1A and disclosing a cross-brace.

FIG. 2 is a rear elevational view of the assembly in FIG. 1A.

FIG. 3 is a horizontal sectional view taken in direction of the arrows and-along the plane of line 3-3 in FIG. 2.

FIG. 4 is a horizontal sectional view taken in direction of the arrows and along the plane of line 4-4 in FIG. 1A.

FIG. 5A is a front elevational view of another embodiment of the assembly having a container wherein a soda/confectionary mixture is formed and including a pair of straws secured to the container.

FIG. 5B is a horizontal sectional view taken in direction of the arrows and along the plane of line 5B-5B in FIG. 5A.

FIG. 6 is a rear elevational view of the assembly of FIG. 5A.

FIG. 7 is a horizontal sectional view taken in direction of the arrows and along the plane of line 7-7 in FIG. 6.

FIG. 8A is a front elevational view of another embodiment of the assembly having a container wherein a soda/confectionary mixture is formed and including a pair of straws secured to the container with one of the straws having a can adapter for securing the assembly to the top of a can.

FIG. 8B is a horizontal sectional view taken in direction of the arrows and along the plane of line 8B-8B in FIG. 8A and disclosing an aperture in the top of the can with a bottom straw passing through the aperture.

FIG. 9 is a rear elevational view of the assembly in FIG. 8A.

FIG. 10 is a front elevational view of another embodiment of the assembly having a container wherein a soda/confectionary mixture is formed and including a pair of straws secured to the container with the bottom straw passing through a collar of a cup adapter for securing the assembly to the rim of a cup.

### DETAILED DESCRIPTION OF EMBODIMENTS OF THE INVENTION

Referring in detail now to the drawings for various embodiments of the present invention and wherein similar parts of the invention are identified by like reference numerals, there is an assembly, generally illustrated as 10, for mixing a liquid (e.g., soda such as coca cola, root beer, etc) with a frozen confectionary (e.g., ice cream, yogurt, or the like). The assembly 10 includes a container 11 suitably defined by a container base 12, and a container top 14 connected to the container base 12. The container top 14 and container base 12 may be connected together in any suitable manner, such as screwed together (i.e., threadably connected together) or snapped together, to preferably have a water tight seal there between. The container base 12 and top 14 may each have any suitable geometric shape, such as a hemispherical hollow shell as shown in the drawings.

The container top 14 has an opening 16 over which a straw 18 is connected to allow the straw 18 to communicate with the insides of the container 11. Thus, any air or liquid mixture inside of the container 11 may be readily removed. The straw 18 may contain a cross-brace 20 to prevent clumps of ice cream from traveling up and/or down the straw 18. The cross-brace 20 may also prevent the straw 18 from collapsing when a vacuum is placed in the straw 18, such as by sucking, to remove air and liquid mixture from inside the container 11. The container base 12 has an opening 23 wherethrough liquid (e.g., soda such as root beer or coca cola) may pass after leaving a container, generally illustrated as 25.

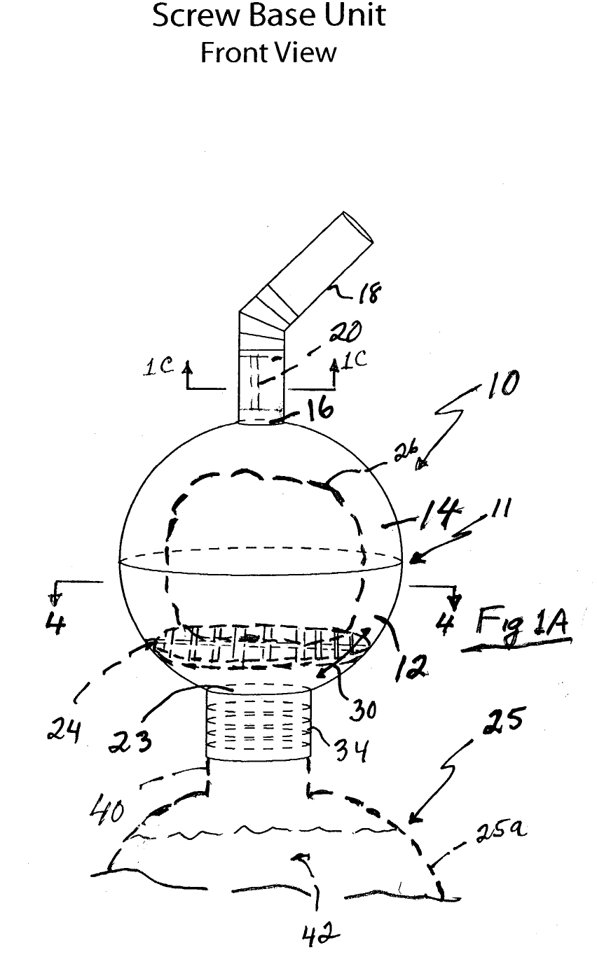

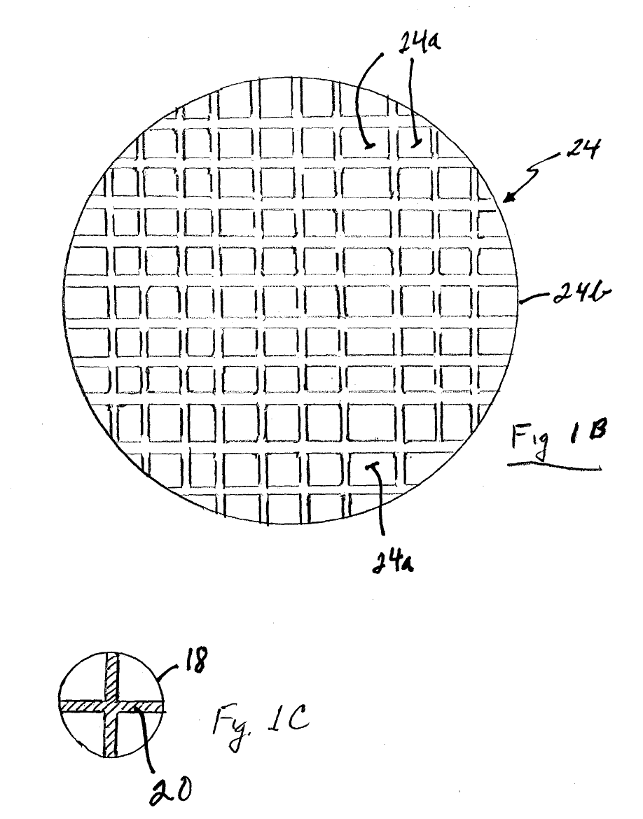

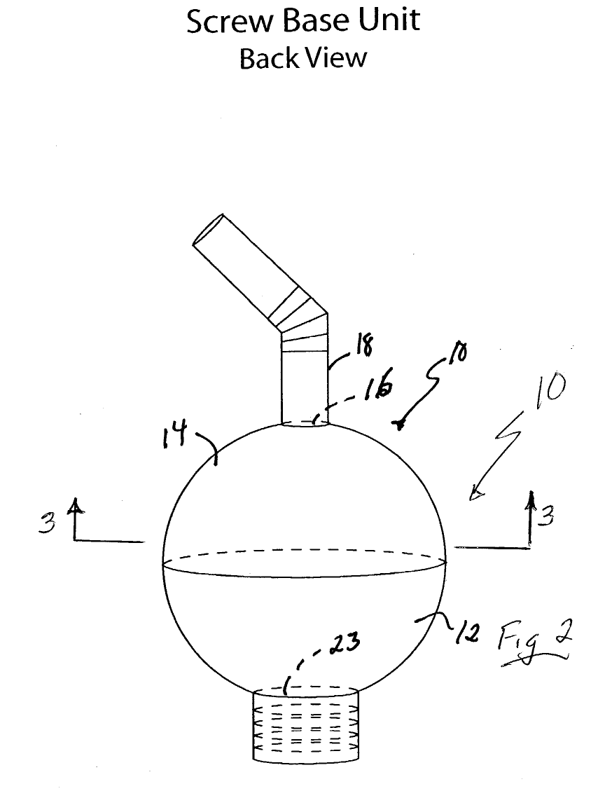

The container 11 (e.g., the container base 12) may include a suitable platform 24 for supporting frozen confectionary 26 (e.g., such as ice cream, yogurt, or the like) off of the bottom of the container 11 and away from opening 23. It is apparent that if frozen confectionary 26 covered opening 23, a vacuum placed on straw 18 would prevent liquid from leaving container 25. The platform 24 may be any suitable platform, preferably a grid-like structure having at least one aperture 24a, more preferably a plurality of apertures 24a as best shown in FIG. 1B. As best shown in FIG. 4, the frozen confectionary 26 is preferably disposed away from an inside surface of the container 11 (e.g., the container base 12) so as to leave an air space 30 (see FIGS. 1A and 4) for the liquid soda to pass through after the liquid soda leaves the container 25. In another embodiment of the invention the frozen confectionary 26 may be spaced from a periphery 24b of the platform 24. The assembly 10, including its associated container 11 having frozen confectionary 26, may be placed in a freezer until ready for use.

Referring now to FIGS. 1A-4 for an embodiment of the invention, there is seen a container neck 34 connected to the container 11 (i.e., to the container base 12) in a depending relationship and being internally threaded for conveniently engaging a threaded neck 40 of a bottle 25a, such as a soda bottle, as best shown in FIG. 1A. When the bottle 25a is tilted, soda 42 flows from the bottle 25a, through its associated neck 40, and through opening 23 in the bottom of the container base 12 for mixing with frozen confectionary to produce a soda/confectionary mixture which may be removed from container 11 through straw 18. The straw 18 may also be placed under a vacuum (e.g., from sucking) to assist in the removal of the soda/confectionary mixture. If need be, the container 11 may be suitably vented to facilitate the flow of soda/confectionary mixture through the straw 18.

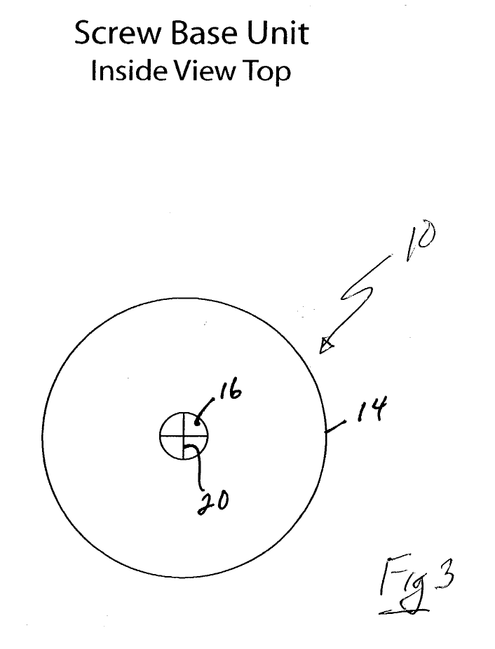

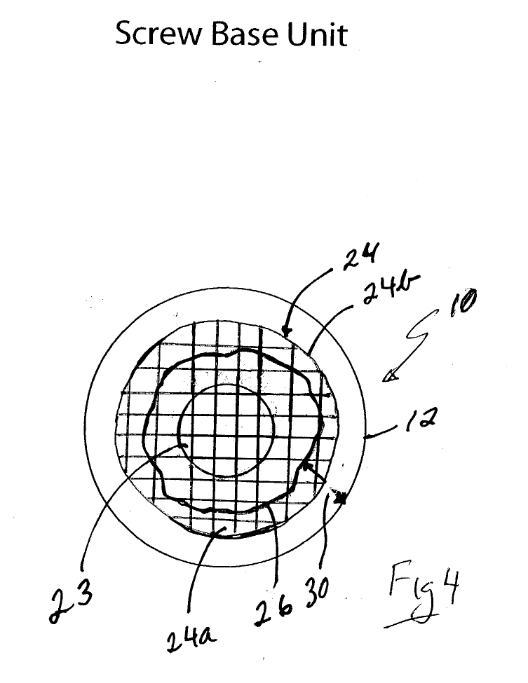

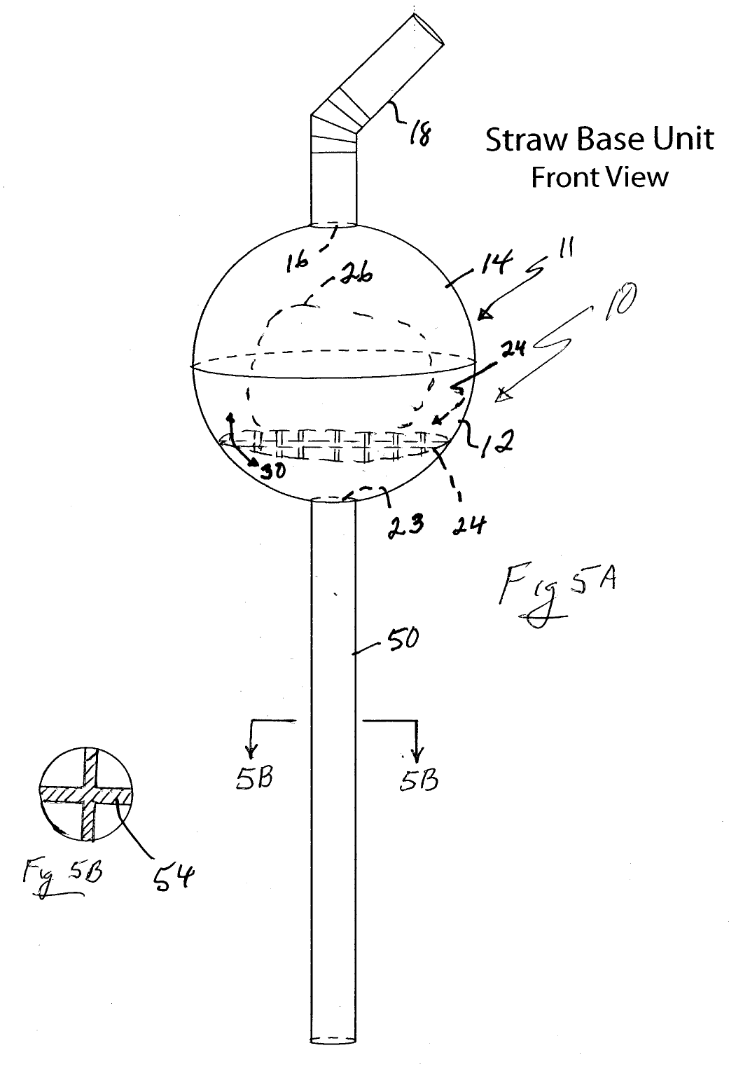

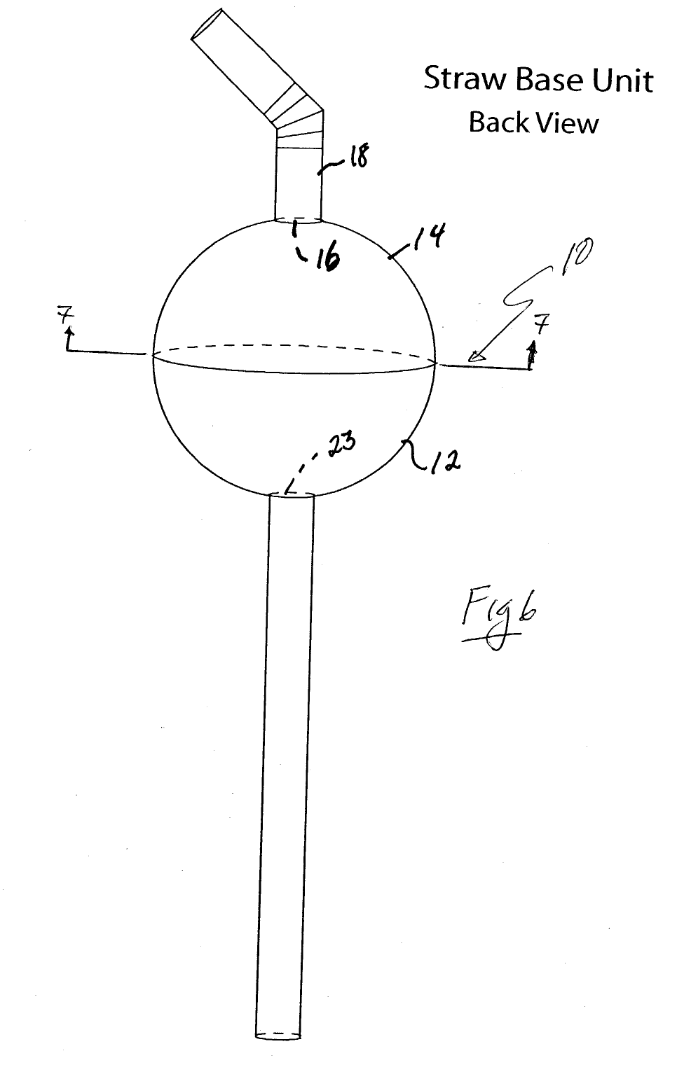

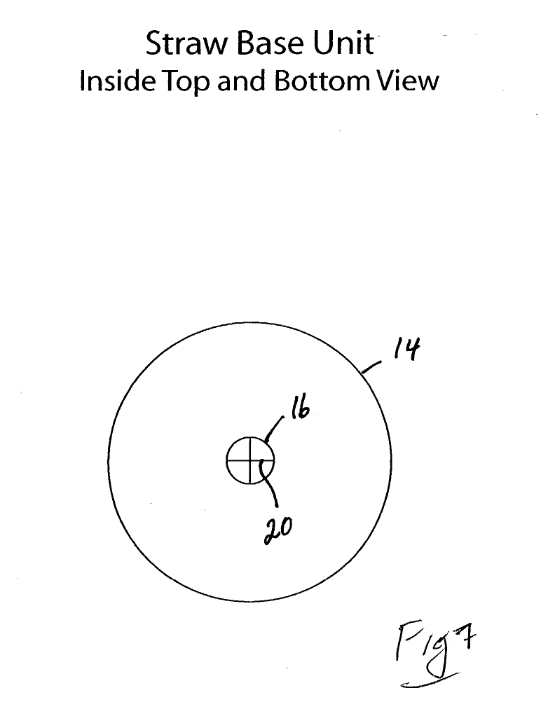

Referring now to FIGS. 5A-7, there is seen another embodiment of the invention wherein a straw 50 is connected to the container 11 (i.e., to the container base 12) in a depending relationship such that the inside of the straw 50 communicates with opening 23. The straw 50 as best shown in FIGS. 5A and 5B may have a cross-brace 54 to prevent clumps of ice cream from traveling up and/or down the straw 50. The cross-brace 54 may also prevent the straw 50 from collapsing under a vacuum. The straw 50 may be inserted into a suitable container 25. When a vacuum is placed in the straw 18 by sucking, the vacuum translates through the container 11 including air space 30, through opening 23 and into the straw 50 causing soda 42 to flow through straw 50, through the opening 23, and into the air space 30 for coming in contact with and/or mixing with the frozen confectionary 26. Continued vacuum or sucking on the straw 18 causes the soda/confectionary mixture to leave the container 11, flowing through opening 16 and through the straw 18.

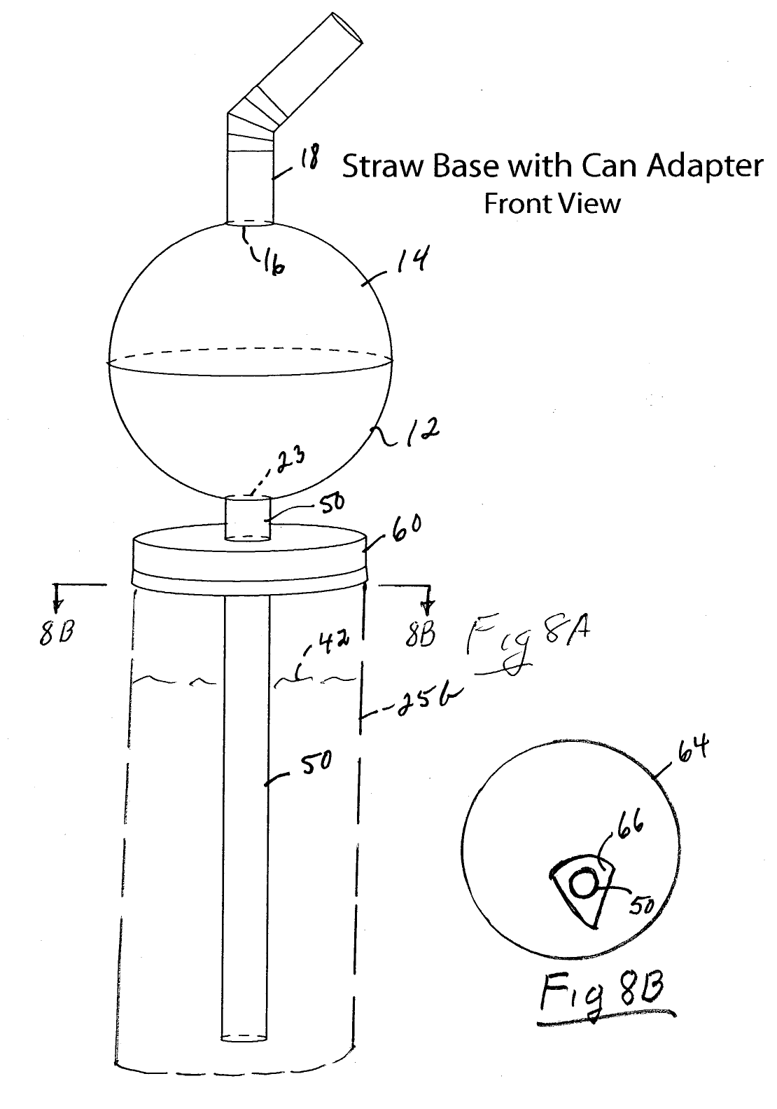

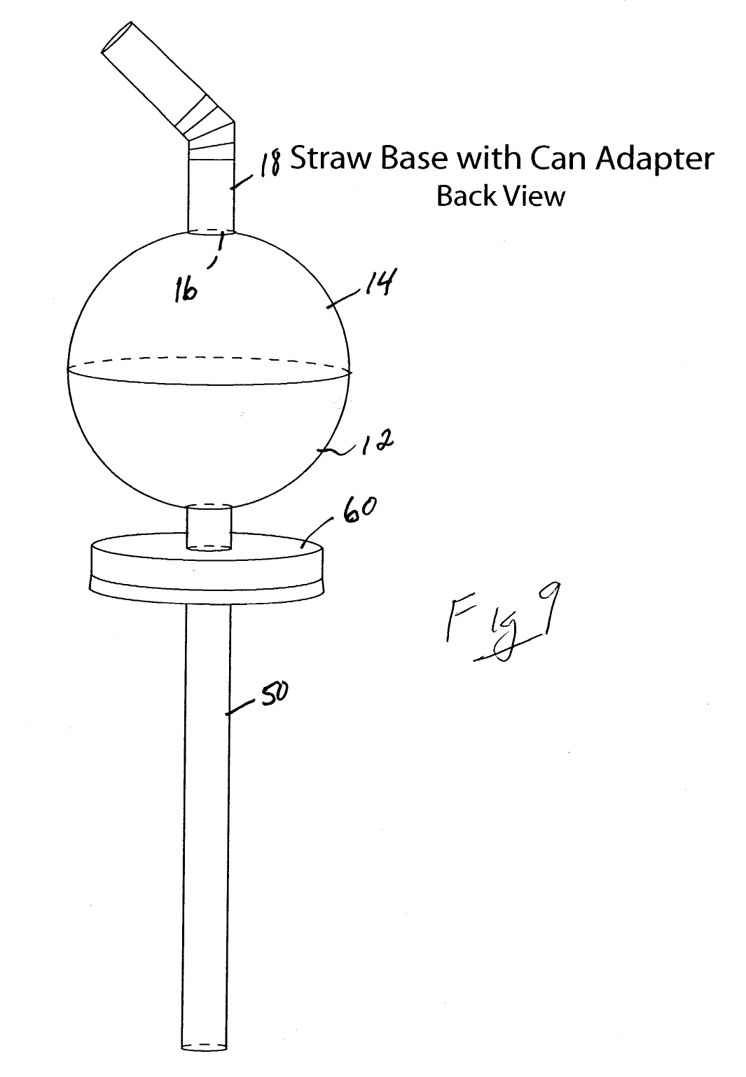

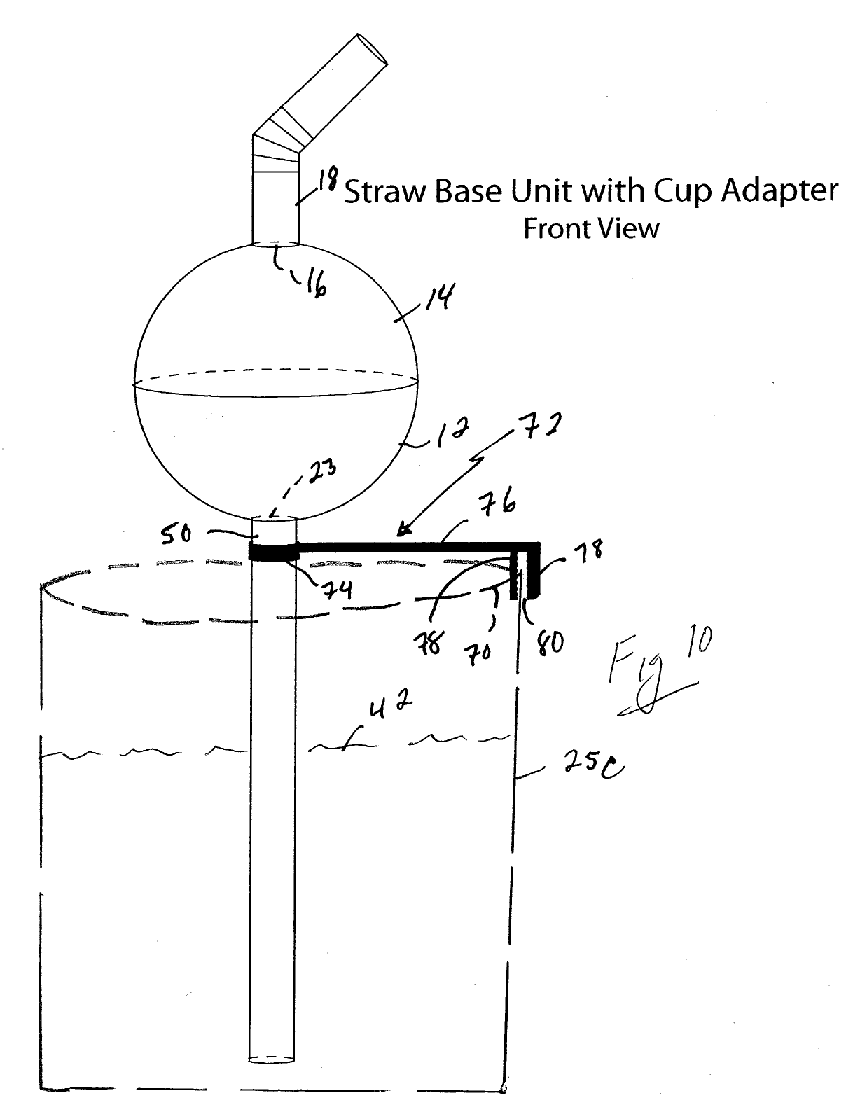

Referring now to FIGS. 8A-9, there is seen another embodiment of the invention wherein the straw 50 slidably passes through a can adapter 60 to snugly snap over and engage a top 64 of a can 25b containing soda 42. The top 64 typically contains a tab (not shown) which when removed from the top 64 exposes an aperture 66 through which soda 42 may pass. The straw 50 may alternatively pass through the aperture 66 such that when a vacuum is placed in the straw 18 by sucking, the vacuum translates through the container 11 including air space 30, through opening 23 and into the straw 50 causing soda 42 to flow from the can 25b, through the straw 50, through the opening 23, and into the air space 30 for coming in contact with and/or mixing with the frozen confectionary 26. As was seen for the embodiment of the invention illustrated in FIGS. 5A-7, a continued vacuum or sucking on the straw 18 causes the soda/confectionary mixture to leave the container 11, flowing through opening 16 and through the straw 18.

Referring now to FIG. 10, there is seen yet another embodiment of the invention wherein the straw 50 slidably passes through a collar 74 of a cup adapter 72 which is for coupling the straw 50 to a cup 25c containing the soda 42. The cup adapter 72 also includes a pair of bifurcated clamps 78-78 connected to an adapter arm 76 which in turn attaches to the collar 74. The bifurcated clamps 78-78 form a space 80 into which a rim 70 of the cup 25c passes to be appropriately engaged and held. As was seen for the embodiments of the invention in FIGS. 5A-7 and 8A-9, when a vacuum is placed in the straw 18 by sucking, the vacuum translates through the container 11 including air space 30, through opening 23 and into the straw 50 causing soda 42 to flow from the cup 25c, through the straw 50, through the opening 23, and into the air space 30 for coming in contact with and/or mixing with the frozen confectionary 26. As was seen for the embodiment of the invention illustrated in FIGS. 8A-9 a continued vacuum or sucking on the straw 18 causes the soda/confectionary mixture to leave the container 11, flowing through opening 16 and through the straw 18.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for preparing a soda/confectionary mixture comprising:
coupling a base to a bottle containing soda;
disposing a frozen confectionary in the base;
coupling a top to the base to produce a container having the frozen confectionary;
contacting the frozen confectionary with the soda for producing a soda/confectionary mixture within the container; and
removing the soda/confectionary mixture from the container.

2. The method of claim 1 additionally comprising removing the soda from the bottle prior to contacting the frozen confectionary with the soda.

3. The method of claim 1 wherein said removing the soda/confectionary mixture from the container comprises passing the soda/confectionary mixture through a straw.

4. The method of claim 2 wherein said removing the soda/confectionary mixture from the container comprises passing the soda/confectionary mixture through a straw.

5. The method of claim 2 wherein said removing the soda from the bottle comprises tilting the bottle so the soda flows by gravity from the bottle.

6. The method of claim 4 wherein said removing the soda from the bottle comprises tilting the bottle so the soda flows by gravity from the bottle.

7. The method of claim 6 wherein said removing the soda/confectionary mixture from the container comprises sucking on the straw to cause the soda/confectionary mixture to flow through the straw.

8. The method of claim 1 wherein said coupling of the top to the base produces a generally water tight fit between the top and the base.

9. The method of claim 8 wherein said coupling of the top to the base comprises threadably engaging the top with the base.

10. The method of claim 1 additionally comprising positioning a platform in the base prior to the disposing the frozen confectionary in the base.

11. The method of claim 9 additionally comprising positioning a platform in the base prior to the disposing the frozen confectionary in the base.

12. The method of claim 11 wherein said platform supports said frozen confectionary, and said method comprises preventing clumps of confectionary from passing through the straw.

13. The method of claim 11 wherein said platform comprises a grid and said disposing a frozen confectionary in the base includes spacing the frozen confectionary from an inside surface of the base so as to leave an air space for the soda to pass through after the soda leaves the bottle, and said straw includes a cross-brace secured to the inside surface of the straw.

14. A method for preparing a soda/confectionary mixture comprising:
inserting into soda a base straw depending from a base;
disposing a frozen confectionary in the base;
coupling a top to the base to produce a container having the frozen confectionary;
creating a vacuum in a top straw extending from the top to cause soda to flow through the base straw and contact the frozen confectionary to produce a soda/confectionary mixture within the container; and
continuing the creating of the vacuum in the top straw for removing the soda/confectionary mixture from the container.

15. The method of claim 14 additionally comprising positioning a platform in the base prior to the disposing the frozen confectionary in the base, and said frozen confectionary is disposed on the platform.

16. The method of claim 15 wherein said platform comprises a grid and said disposing a frozen confectionary in the base includes spacing the frozen confectionary from an inside surface of the base so as to leave an air space for the soda to pass through after the soda leaves the bottle, and said base straw includes a cross-brace secured to the inside surface of the base straw.

17. The method of claim 15 wherein said soda is disposed in a can, and said method additionally comprises producing an aperture in said can, passing the base straw through the aperture and into the soda, passing the base straw through a cap, and coupling the cap over the top of the can.

18. The method of claim 15 wherein said soda is disposed in a cup, and said method additionally comprises passing the base straw through a collar of an adapter assembly, and inserting a rim of the cup into space between bifurcated coupling members of the adapter assembly.

19. The method of claim 1 additionally comprising placing the container having the frozen confectionary in a freezer and said method comprises preventing clumps of confectionary from passing through the straw.

20. An assembly for mixing soda with a ice cream comprising soda, a frozen confectionary disposed in a container communicating with the soda, and at least one straw secured to the container.
